(19) United States
(12) Patent Application Publication
(10) Pub. No.: US 2014/0125024 A1
(43) Pub. Date: May 8, 2014

(54) TIE ROD TUBE ASSEMBLY AND METHOD OF FORMING BY MAGNETIC PULSE WELDING

(71) Applicant: Dana Automotive Systems Group, LLC, Maumee, OH (US)

(72) Inventors: Phillip E. Deierling, Toledo, OH (US); Mark A. Davis, Kalamazoo, MI (US); Jeffrey A. Dutkiewicz, Toledo, OH (US)

(73) Assignee: DANA AUTOMOTIVE SYSTEMS GROUP, LLC, Maumee, OH (US)

(21) Appl. No.: 14/074,141

(22) Filed: Nov. 7, 2013

Related U.S. Application Data
(60) Provisional application No. 61/723,720, filed on Nov. 7, 2012.

(51) Int. Cl. B62D 7/20; B23K 20/06

(52) U.S. Cl. CPC B62D 7/20; B23K 20/06
USPC 280/93.51; 72/56

(57) ABSTRACT

A method of forming a tie rod tube assembly by magnetic pulse welding is provided. The method can be used to form tie rod assemblies with a tie rod tube centerpiece that is parabolic in shape. In addition, the method can be used to form a tie rod assembly where the end fittings and centerpiece are made from different materials. Also described is a tie rod assembly manufactured using the method or methods of the invention.

### RELATED APPLICATIONS

This application is claiming the benefit, under 35 U.S.C. §119(e), of the provisional application filed on Nov. 7, 2012, under 35 U.S.C. §111(b), which was granted Ser. No. 61/723,720, and is hereby incorporated by reference in its entirety.

### FIELD OF THE INVENTION

The present invention relates to a method of joining end fittings to a tie rod centerpiece using magnetic pulse welding to form a tie rod assembly. In certain embodiments, the end fittings and centerpiece are made from different materials. In other embodiments, the centerpiece is a parabolic shape rather than perfectly cylindrical.

### BACKGROUND OF THE INVENTION

The present invention relates generally to a method of fabricating tie rod assemblies to be used in a steering mechanism and more specifically, to a method of attaching metal end-fittings to tubular shaft centerpieces. A complete tie rod assembly includes a hollow cylindrical or near cylindrical parabolic shaped centerpiece portion of a desired length with end fittings located in the ends of the centerpiece. The end fittings can be any known in the art. Frequently, the end fittings are yokes, such as those used in universal joints.

Conventionally, end fittings and centerpiece tubes are formed from steel and are joined by conventional welding processes. However, certain benefits have been found if components of the tie rod assembly are made from a lighter material than steel. If the tie rod assembly is used on a motorized vehicle, in order to reduce vehicular weight, obtain smooth operation, and improve fuel economy, tie rod components have been formed from lighter materials such as aluminum, aluminum alloys, or high-strength aluminum alloys such as 6061T. While aluminum, aluminum alloys, or high-strength aluminum alloys such as 6061T have been an acceptable material because of their strength and lighter weight, problems have been experienced using conventional welding techniques with such components. For example, aluminum containing components have been weakened by heat generated and transferred to them during conventional welding.

Magnetic pulse welding (MPW) has found to be a viable alternative to convention welding when aluminum or aluminum alloys, or high-strength aluminum alloys such as 6061T, are used in vehicular components, such as with tie rod assemblies. MPW is a known prior art method of pressure welding is based on the use of interaction of magnetic fields, produced by an inductor through which an impulse of high intensity current is passed. The parts to be welded are positioned in spaced relation at an angle therebetween and the method can be used for obtaining overlapping welded joints of thin-walled parts having different thickness and made from different materials without melting. The method is described in U.S. Pat. No. 3,520,049, to Lysenko et al.

Further, an improvement in welding tubular parts of large diameter using MPW is described by Yablochnikov in “Apparatus for MPW Large Diameter, Thin-Walled Pipes”; Avt. Svarka, 1983, No. 4 pp. 48 51, 58, and U.S. Pat. No. 4,129,846 to Yablochnikov. More specifically, MPW has been used to attach end fittings to a drive shaft tube as described in U.S. Pat. No. 7,015,435 ('435 patent) to Yablochnikov. However, it does not address tie rod assemblies, nor tie rod centerpieces of a parabolic shape, nor does it address the specific needs for manufacturing tie rod assemblies with end fittings and centerpieces from different materials. Nevertheless, because the '435 patent describes the MPW process as contemplated for this invention, but for driveshaft assemblies rather than tie rod assemblies, the '435 patent is hereby incorporated by reference in its entirety to the extent permitted by law.

U.S. Pat. No. 6,860,013 ('013 patent), which is hereby included by reference in its entirety to the extent permitted by law, discloses a method of forming a vehicle suspension assembly by joining two vehicle suspension components made from the same or dissimilar materials. The vehicle suspension assembly is formed of a central shaft portion and two end portions. The central shaft portion is formed of aluminum. The end portions can be formed of steel or a comparable material. The '013 patent discloses that a portion of one of the first and second suspension components is positioned within a portion of the other of the suspension components in an overlapping manner. For example, the end portion may include a flange which is adapted to be received within an open end of the shaft portion. The assembly may be formed by magnetic pulse welding. The '013 patent teaches that the method disclosed therein is suitable to form a joint between axle components made from any two dissimilar metals. However, it does not specify that the tubular centerpiece of a tie rod assembly can be parabolic in shape, nor does it address the specific needs for manufacturing tie rod assemblies with end fittings and centerpieces from different materials.

U.S. Pat. No. 4,348,247 discloses a tubular structure. The assembly is comprised of a tube and a pair of end members. It shows that the end members fit within the ends of the tube. The end members are welded to the tube to provide metal to metal contact. It is disclosed that steel is a preferred material for the tube but that other materials such as aluminum can be utilized. However, it does not specify that the tubular centerpiece of a tie rod assembly can be parabolic in shape, nor does it discuss MPW, nor does it address the specific needs for manufacturing tie rod assemblies with end fittings and centerpieces from different materials.

U.S. Pat. No. 7,547,028 discloses a steering linkage assembly. The assembly comprises a tubular member extending between first and second tie rod elements. The tubular member can be formed of aluminum and have a round cross section or be of another suitable geometrical cross sectional shape such as a square, hexagonal, octagonal and the like. However, it does not specify that the tubular centerpiece of a tie rod assembly can be parabolic in shape, nor does it discuss MPW, nor does it address the specific needs for manufacturing tie rod assemblies with end fittings and centerpieces from different materials.

U.S. Pat. No. 6,913,273 discloses a control arm which includes a connection tube and a pair of mounting eyes. Each mounting eye is attached to an opposite end of the tube. The connection tube is formed of an aluminum alloy. However, it does not specify that the tubular centerpiece of a tie rod assembly can be parabolic in shape, nor does it discuss MPW, nor does it address the specific needs for manufacturing tie rod assemblies with end fittings and centerpieces from different materials.

Therefore, the need for a method of forming a tie rod assembly using MPW is still needed. A need also exists for having the centerpiece of the tie rod assembly having a nearly cylindrical shape, such as parabolic. A further need exists for a method of tie rod assemblies constructed of a centerpiece and end fittings made of different materials. In addition, any article manufactured by such a method is desirable for the reasons discussed above. The embodiments described herein address these needs.

### SUMMARY OF THE INVENTION

The present invention is directed toward a method for forming a tie rod assembly by magnetic pulse welding. The method is practiced by providing a centerpiece, providing at least one end fitting, and positioning the at least one end fitting within an end portion of the centerpiece and generating a magnetic field to magnetic pulse weld the centerpiece to the at least one end fitting, thereby attaching the centerpiece to the at least one end fitting.

In one embodiment of the method, the centerpiece has a parabolic shape. In another embodiment, the centerpiece and the at least one end fitting are made from different materials. In one embodiment, for example, the centerpiece is made from aluminum. In another embodiment, for example, the at least one end fitting is made from steel. The method may be used to produce a tie rod assembly that weighs at least 20 percent less than other known assemblies.

The inventions also includes tie rod assemblies made using any of the method embodiments described herein.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a perspective view of an embodiment of the tie-rod tube assembly in accordance with the present invention and in use as an element of a truck steer axle.

FIG. 2 is a perspective view of a pair of tie-rod end fittings and tie-rod tube prior to magnetic pulse welding the tie-rod end fittings and tie-rod tube in accordance with the present invention.

FIG. 3 is a perspective view of a pair of tie-rod end fittings and tie-rod tube prior to magnetic pulse welding the tie-rod end fittings and tie-rod tube in accordance with the present invention.

FIG. 4 is a perspective view of an embodiment of a tie-rod tube suitable for use in the present invention.

FIG. 5 is a perspective view of another embodiment of a tie-rod tube suitable for use in the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific assemblies, methods and features illustrated in the attached drawings, and described in the following specification are simply exemplary embodiments of the inventive concepts. Hence, specific dimensions, directions, or other physical characteristics relating to the embodiments disclosed are not to be considered as limiting, unless expressly stated otherwise. Also, although they may not be, like elements in various embodiments may be commonly referred to with like reference numerals within this section of the application.

As used herein and in the claims, the term steel can mean steel or any steel alloy. The term aluminum can mean aluminum, aluminum alloys, or high-strength aluminum alloys, such as 6061T as only one example. Further, the term magnetic pulse welding (MPW) is as described in U.S. Pat. No. 7,015,435, which is hereby incorporated by reference in its entirety to the extent permitted by law. Should any document hereby incorporated by reference be found to conflict with the instant disclosure or claims, the instant disclosure or claims will control.

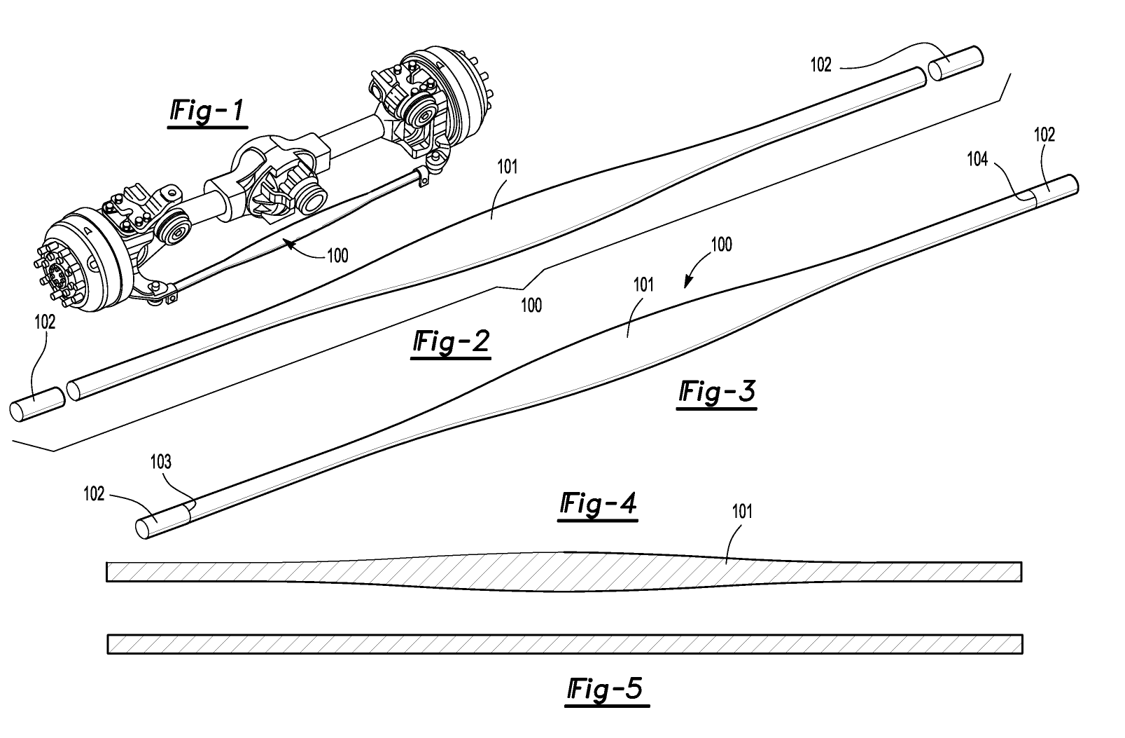

As shown in FIG. 1, a generic steer axle including a tie rod tube assembly 100 is provided. As shown in FIGS. 2 and 3, the tie rod tube assembly 100 has a tie rod tube centerpiece 101 and a pair of end fittings 102 disposed at opposite ends of the centerpiece 101. The end fittings 102 are of conventional configurations known in the art, such as, but not limited to, a yoke shape, for example.

In some embodiments, the centerpiece 101 may be of a parabolic shape as shown in FIGS. 1-4. In other embodiments the centerpiece 101 may be cylindrical as shown in FIG. 5. In yet other embodiments, the tie rod tube centerpiece 101 may be near cylindrical or have other shapes including, but not limited to an oval or square cross-section. In addition, the cross section of the centerpiece 101 may be constant throughout its length or may vary.

In an embodiment, the tie rod tube assembly 100 is a bi-material assembly. Preferably, in this embodiment, the tie rod tube centerpiece 101 and end fittings 102 are formed of different materials. For example, in an embodiment, the centerpiece 101 is made of aluminum and the end fittings 102 are made of steel. In one embodiment, the tie rod tube assembly 100 weighs at least 39 percent less than other known assemblies. In other embodiments, the tie rod assembly weighs at least 30 percent less than other known assemblies. In still other embodiments, the tie rod assembly weighs at least 20 percent less than other known assemblies. However, in other embodiments, the centerpiece 101 and end fittings 102 are formed from the same materials. In one such embodiment, both the tie rod tube centerpiece and end fittings may be made of aluminum.

A method of forming a tie rod tube assembly by magnetic pulse welding is also provided. In an embodiment, the method is practiced by positioning the end fittings 102 on opposite ends of the tie rod tube centerpiece 101. In another embodiment, an end portion 103, 104 of the centerpiece 101 is disposed over each end fitting 102. Next, the end fittings 102 are positioned so that a magnetic coil can propel a portion of the tie rod tube centerpiece 101 into each end fitting 102. Propelling the tie rod tube centerpiece 101 into the end fittings 102 permanently secures the centerpiece 101 to the end fittings 102 and forms the tie rod assembly 100. In an embodiment, the tie rod tube centerpiece 101 is permanently secured to each end fittings 102 via a metallurgical bond.

The method comprises forming the tie rod tube assembly 1000 by a MPW process. The MPW process is practiced as described in U.S. Pat. No. 7,015,435 and as above-described and includes utilizing the tie rod tube centerpiece 101 and end fittings 102 to form the tie rod tube assembly 100.

While the method has been described in connection with forming a tie rod tube assembly 100, it should be appreciated that the method may have applications to other bi-material assemblies. Thus, in certain embodiments, the method is not limited to forming a tie rod tube assembly. For example, in another embodiment, the method may be utilized to form non-driving steer axles. In this embodiment, a center structure is joined to a steel spindle end via an MPW process. In this embodiment, the center structure can be made of aluminum and the spindle ends can be made of steel.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed:

1. A method for forming a tie rod assembly by magnetic pulse welding, comprising:
providing a centerpiece;
providing at least one end fitting;
positioning the at least one end fitting within an end portion of the centerpiece; and generating a magnetic field to magnetic pulse weld the centerpiece to the at least one end fitting, thereby attaching the centerpiece to the at least one end fitting.

2. The method of claim 1 wherein the centerpiece has a parabolic shape.

3. The method of claim 1 wherein the centerpiece and the at least one end fitting are made from different materials.

4. The method of claim 3 wherein the centerpiece is made from aluminum.

5. The method of claim 3 wherein the at least one end fitting is made from steel.

6. The method of claim 4, wherein the tie rod assembly weighs at least 20 percent less than other known assemblies

7. A tie rod assembly manufactured using the method of claim 1.

8. The tie rod assembly of claim 7, wherein the centerpiece has a parabolic shape.

9. The tie rod assembly of claim 7, wherein the centerpiece and the at least one end fitting are made from different materials.

10. The tie rod assembly of claim 7, wherein the centerpiece is made from aluminum.

11. The tie rod assembly of claim 7, wherein the at least one end fitting is made from steel.

12. The tie rod assembly of claim 10, wherein the tie rod assembly weighs at least 20 percent less than other known assemblies.
